(19) United States
(12) Patent Application Publication
(10) Pub. No.: US 2020/0109687 A1
(43) Pub. Date: Apr. 9, 2020

(54) FUEL INJECTION DEVICE AND FUEL HEATING METHOD

(71) Applicant: Robert Bosch GmbH, Stuttgart (DE)

(72) Inventors: Tian Zhang, Wuxi, Jiangsu (CN); Xuexin Lin, Wuxi, Jiangsu (CN); Yong Chen, Wuxi, Jiangsu (CN)

(21) Appl. No.: 16/617,570

(22) PCT Filed: May 8, 2018
(86) PCT No.: PCT/EP2018/061867

§ 371 Date: Nov. 27, 2019

(30) Foreign Application Priority Data
May 27, 2017 (CN) 201710390659.6

(51) Int. Cl. F02M 55/02; F02M 31/125

(52) U.S. Cl. CPC F02M 55/025; F02M 69/465; F02M 31/125

(57) ABSTRACT

A fuel injection device comprising an interface member, a fuel distributor passage, at least one injection valve and a heating unit, wherein the interface member is provided on the fuel distributor passage and is connected to a fuel tank to control fuel fed into the fuel distributor passage, the at least one injection valve is connected to the fuel distributor passage, and the fuel is distributed into the at least one injection valve via the fuel distributor passage, the heating unit is used to heat the fuel in the fuel distributor passage, the heating unit comprises a connector, and the heating unit is connected to an energy storage apparatus via the connector.

### TECHNICAL FIELD

The present invention relates to a fuel injection device for injecting fuel in an internal combustion engine, and more particularly to a fuel distributor in a fuel injection device for distributing fuel to a plurality of fuel injection valves. The present invention also relates to a method for heating fuel in a fuel injection device.

### BACKGROUND ART

There have been fuel injection devices using natural gas as fuel. The fuel injection device has a fuel distributor for distributing natural gas to a plurality of injection valves. The fuel distributor comprises a passage disposed therein, the passage being connected to a fuel tank. The fuel tank is used to store natural gas, particularly LNG (Liquefied Natural Gas, liquefied natural gas). A sensor is mounted on a fuel distributor plate to measure the pressure and temperature of the natural gas in the fuel distributor plate.

In some specific use environments, such as high altitude or cold areas, the temperature of the natural gas supplied from the fuel tank through the pipe to the fuel injection device may be lower than a predefined temperature value, resulting in insufficient gasification of the natural gas. When the fuel temperature is too low, it may cause the failure of a sealing ring of the injection valve, which may lead to problems such as fuel leakage, difficulty in opening the injection valve, slow response, low gas temperature, poor start-up performance of the internal combustion engine, multiple start-ups and high exhaust emission. In these cases, in order to protect the normal operation of the fuel injection device, a controller will typically perform operations such as downtime or downgrade, resulting in restrictions on use.

There is therefore a need to introduce additional considerations and solutions to detect whether the temperature of the fuel in the fuel injection device meets the requirements and take appropriate measures to ensure the normal operation of the fuel injection device.

### SUMMARY OF THE INVENTION

In view of the problems existing in the prior art, the present invention discloses a fuel injection device for distributing fuel to a plurality of fuel injection valves, and the technical solution of the present invention is realized as follows:
a fuel injection device, characterized by comprising an interface member, a fuel distributor passage, at least one injection valve and a heating unit, wherein the interface member is provided on the fuel distributor passage and is connected to a fuel tank to control fuel fed into the fuel distributor passage, the at least one injection valve is connected to the fuel distributor passage, and the fuel is distributed into the at least one injection valve via the fuel distributor passage, the heating unit is provided in the fuel distributor passage, the heating unit comprises a connector provided on the fuel distributor passage, and the heating unit is connected to an energy storage apparatus via the connector.

The present application further discloses a fuel heating method used in a fuel injection device, and the method is realized as follows:

a fuel heating method used in a fuel injection device, the fuel injection device comprising a fuel distributor passage, wherein the method comprises the following steps:
detecting the temperature of fuel in the fuel injection device;
determining that the fuel in the fuel injection device needs to be heated when the detected temperature of the fuel in the fuel injection device is in a predefined temperature range; and
activating the heating unit provided in the fuel distributor passage to heat the fuel.

The present application further discloses a non-volatile memory storing a computer program therein, the computer program enabling a computer to execute the abovementioned method used in a fuel distributor device.

The fuel injection device comprising the heating unit provided in the fuel distributor passage, the fuel heating method, and the non-volatile memory according to the above-described embodiments realize the heating of fuel, particularly the heating of natural gas, before being injected to the injection valve in the fuel injection device, and protect the injection valve when the fuel temperature is too low, while improving the fuel injection device and start-up characteristics of the internal combustion engine, so that they can work according to design requirements, improving the adaptability of the internal combustion engine.

### BRIEF DESCRIPTION OF THE DRAWINGS

In order to more clearly illustrate technical solutions in the embodiments of the present application or in the prior art, a brief introduction to the drawings required for the description of the embodiments or the prior art will be provided below. Obviously, the drawings in the following description are some specific embodiments of the present application, and those of ordinary skill in the art would also be able to obtain other drawings from these drawings without expending any inventive effort.

FIG. 1 shows a schematic cross-sectional view of a fuel injection device according to a particular embodiment of the present invention;

FIG. 2 shows a schematic perspective view of a fuel injection device according to another embodiment of the present invention;

FIG. 3 shows a schematic cross-sectional view of the fuel injection device according to another embodiment of the present invention in FIG. 2; and

FIG. 4 shows a flow diagram of a fuel heating method used in a fuel injection device according to a particular embodiment of the present invention.

### DETAILED DESCRIPTION OF EMBODIMENTS

The illustrative examples of the present invention will now be described with reference to the accompanying drawings, wherein like reference numerals refer to like elements.

The examples described below facilitate the understanding of the present invention by those skilled in the art, and the examples are intended to be illustrative and not restrictive. The graphical representation of the elements, components, modules, devices, and apparatus bodies in the figures only shows that these elements, components, modules, devices, and apparatus bodies exist and also indicates the relative relationship between them, but is not intended to define their specific shape. The relationship between the steps in the flow diagram is not limited to the order given and may be adjusted according to practical application without departing from the scope of protection of the present application.

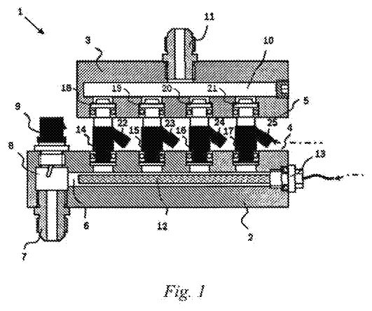

FIG. 1 is a schematic cross-sectional view of a fuel injection device 1 according to a first particular embodiment of the present invention. As shown, the fuel injection device 1 may in particular be configured in a block shape. The fuel injection device 1 is a fuel injection device of an internal combustion engine suitable for mixed compression and external-source ignition. In the present embodiment, the fuel injection device 1 is particularly suitable for injecting natural gas, particularly LNG. The fuel injection device 1 may also be used to distribute other fuels.

The fuel injection device 1 has a first block element 2 and a second block element 3, with the first block element preferably serving as a fuel distributor. The fuel injection device 1 may also comprise a plurality of second block elements 3. The first block element 2 has a side face (upper side face) 4. The second block element 3 has a side face (lower side face) 5. The first block element 2 has a fuel distributor passage 6, and the fuel distributor passage 6 is specifically disposed inside the first block element 2. In the present embodiment, an interface member 7 is mounted on the first block element 2, and LNG is guided into the fuel distributor passage 6 through the interface 7. For this purpose, the interface member 7 is connected in a suitable manner to a fuel tank, in particular a gas tank. In the present embodiment, the interface member 7 is specifically provided at one end of the fuel distributor passage 6. In addition, a sensor 8 having a plug 9 is mounted on the first block element 2. The sensor 8 is used, for example, for measuring the pressure and temperature of the fuel in the fuel distributor passage 6.

The sensor 8 can be connected to a controller via the plug 9. In the present embodiment, the sensor 8 is provided at one end of the fuel distributor passage 6 in the first block element 2 near the interface member 7.

Injection valves 14, 15, 16 and 17 are provided in the fuel injection device 1, in particular between the first block element 2 and the second block element 3. In the present embodiment, the injection valves 16 and 17 are provided in addition to the first injection valve 14 and the second injection valve 15. Further, the number of the injection valves 16 and 17 is defined for each application case. The number of injection valves is not limited to two injection valves 14 and 15, and may be greater than 2, particularly greater than 4.

The injection valves 14, 15, 16, 17 are inserted into the second block element 3 by the first block element 2. Sealing rings 18, 19, 20 and 21 having elasticity are provided in the second block element 3. The sealing rings 18, 19, 20 and 21 ensure that vibration between the injection valves 14, 15, 16 and 17 and the second block element 3 is dampened. In particular, the vibration of the second block element 3 is prevented from adversely affecting the function of the injection valves 14, 15, 16 and 17.

The heating unit 12 is used to heat the fuel in the fuel distributor passage 6. The heating unit 12 has a connector 13, and the heating unit 12 is connected to an energy storage apparatus via the connector 13. For the purpose of heating, the heating unit 12 may be integrally or partially disposed within the fuel distributor passage 6 or affixed to an outer wall of the fuel distributor passage 6. In the present embodiment, the heating unit 12 is provided in the fuel distributor passage 6. The heating unit 12 has, in particular, a connector 13, and the connector 13 is provided in the first block element 2, for example, on the fuel distributor passage 6. The heating unit 12 is connected to an energy storage apparatus such as a storage battery through the connector 13. In the present embodiment, the connector 13 is provided at the other end of the fuel distributor passage 6 opposite the interface member 7. The heating unit 12 is composed of a metallic electric heating element or a non-metallic electric heating element. The heating unit 12 may be in various shapes. In the present embodiment, the heating unit 12 is a tubular electric heating rod. The heating unit 12 extends from the connector to the interface member 7. In the present embodiment, the heating unit 12 preferably covers the injection valves 14, 15, 16 and 17. The heating unit 12 is also connected to a controller via the connector 13. The controller controls the energy storage apparatus such that the energy storage apparatus outputs a heating current for a certain time to the tubular electric heating rod based on the demand of the heating power.

The injection valves 14, 15, 16 and 17 are mounted in the second block element 3 by the first block element 2. In the area of the upper side face 4 of the first block element 2 and the lower side face 5 of the second block element 3, the injection valves 14, 15, 16, and 17 have connectors 22, 23, 24, and 25 provided thereon, respectively. The connectors 22, 23, 24 and 25 may be connected to the controller.

The second block element 3 has a fuel pressure regulator chamber 10. The LNG guided into the fuel distributor passage 6 through the interface member 7 is distributed to the injection valves 14, 15, 16 and 17, and then the injection valves 14, 15, 16 and 17 inject the LNG into the fuel pressure regulator chamber 10. In the present embodiment, the correspondence amount of the LNG fed from the fuel pressure regulator chamber 10 can be controlled by the injection valves 14, 15, 16 and 17. A connector member 11 is mounted on the second block element 3, so that, via the connector member 11, the fuel pressure regulator chamber 10 can be connected to an intake pipe (not shown) of the internal combustion engine or to a mixing chamber containing air (not shown), that is, the fuel in the fuel pressure regulator chamber 10 can be guided to the intake pipe of the internal combustion engine or to the mixing chamber containing air.

Optionally, the first block element 2 and the second block element 3 are also connected to each other by one or more connection means (not shown) according to the requirements of the actual application situation. The connecting means may be, for example, one or more bolts.

Further, a sealing device (not shown) is provided between the upper side face 4 of the first block element 2 and the lower side face 5 of the second block element 3. The sealing device is preferably a resilient sealing device and is constructed of, for example, an elastic component. The sealing device ensures a certain degree of damping between the first block element 2 and the second block element 3, in particular, to avoid the transmission of vibration.

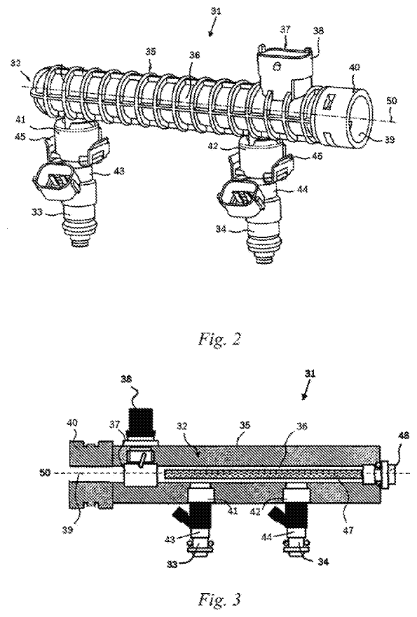

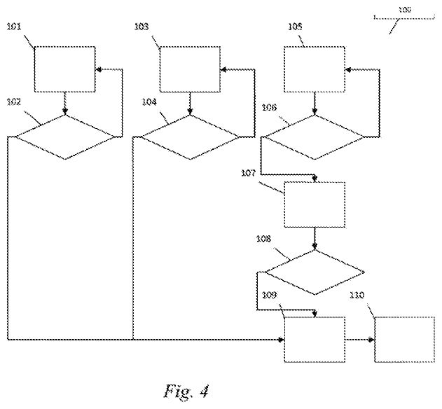

FIGS. 2 and 3 show a fuel injection device 31 according to a second particular embodiment of the present invention. The fuel injection device 31 is particularly configured in a tubular shape. The fuel injection device 31 comprises a fuel distributor 32 and a plurality of injection valves 33 and 34. The fuel distributor 32 is particularly suitable for distributing natural gas, in particular LNG, to the injection valves 33 and 34. The fuel distributor 32 may also be used to distribute other fuels.

The fuel distributor 32 has a base body 35 with a distributor passage 36. In addition, a sensor 37 with a sensor interface 38 is provided. The sensor interface 38 of the sensor 37 is integrated in the base body 35, and thereby, the sensor interface 38 is connected to the distributor passage 36. The sensor interface 38 is preferably integrally formed with the distributor passage 36.

An inner chamber is provided in the distributor passage 36. The inner chamber is preferably used as a fuel chamber 39. A fuel tank, in particular a gas tank, may be connected by means of the interface member 40 provided on the base body 35 to introduce LNG or other fuels into the fuel chamber 39.

The fuel distributor 32 further has outlets 41 and 42. In the present embodiment, the outlets 41 and 42 are formed by the cup bases 41 and 42, and the injection valves 33 and 34 are fixed to the cup bases 41 and 42. In order to fix the injection valves 33 and 34 to the fuel distributor 32, inlet adapters 43 and 44 of the injection valves 33 and 34 are engaged at least in section into the cup bases 41 and 42. The corresponding injection valves 33 and 34 are then connected to the cup bases 41 and 42 with their inlet adapters 43 and 44 by means of retaining means 45 and 46 which are configured as clips 45 and 46. The injection valves 33 and 34 are thus fixed to the cup bases 41 an 42 of the fuel distributor 32.

In the present embodiment, the outlets 41 and 42 may be integrated into the base body 35. The outlets 41 and 42 may also be configured in a modified manner. Thus, the fuel, particularly LNG, can be distributed into the fuel injection valves 33 and 34 from the fuel chamber 39 through the outlets 41 and 42 and the inlet adapters 43 and 44 of the injection valves 33 and 34.

The heating unit 12 is used to heat the fuel in the fuel distributor passage 6. The heating unit 12 has a connector 13, and the heating unit 12 is connected to an energy storage apparatus via the connector 13. For the purpose of heating, the heating unit 12 may be integrally or partially disposed within the fuel distributor passage 6 or affixed to an outer wall of the fuel distributor passage 6. In the present embodiment, the heating unit 47 is provided in the fuel distributor passage 36. The heating unit 47 further comprises in particular a connector 48, and the connector 48 is disposed on the base body 35. The heating unit 47 is connected to the controller via the connector 48. In the present embodiment, the heating unit 47 is composed of a metallic electric heating element or a non-metallic electric heating element. The heating unit may be in various shapes. In the present embodiment, the heating unit 47 is a tubular electric heating rod. Preferably, in the present embodiment, the length of the heating unit 47 covers the injection outlets 41 and 42.

The sensor 37 is preferably a pressure and a temperature sensor. The sensor 37 is connected to the controller via the sensor interface 38.

In the present embodiment, the distributor passage 36 extends along a longitudinal axis 50. It is also contemplated that the configuration of the distributor passage 36 is curved. The fuel injection system 31 may also have more than two fuel injection valves 33 and 34. The number of outlets 41 and 42, in particular cup bases 41 and 42, can be matched with the corresponding application situation.

The fuel injection device comprising the heating unit provided in the fuel distributor passage according to the above-described embodiment realizes the heating of fuel, particularly the heating of natural gas, before being injected to the injection valve in the fuel injection device, and improves the fuel injection device 1 and start-up characteristics of the internal combustion engine, so that they can work according to design requirements, improving the adaptability of the internal combustion engine. In addition, the heating unit is provided in the fuel distributor passage, and the compactness of the structure of the fuel injection device is maintained.

FIG. 4 is a flow diagram of a method 100 for heating fuel within fuel injection devices 1 and 31 according to another embodiment of the present invention. The fuel injection device 1, 31 comprises a heating unit 12, 47 provided in the fuel distributor passages 6, 36, the fuel heating method 100 comprising the following steps:

Step 107: Detecting the temperature of the fuel, in particular the natural gas, guided into the fuel injection device 1, 31, particularly into the fuel distributor passage 6, 36;

Step 108: Determining whether it is necessary to heat the fuel, particularly the natural gas, which is guided into the fuel injection device 1, 31, particularly the fuel distributor passages 6, 36;

and specifically, determining whether it is necessary to heat the fuel guided into the fuel injection device 1, 31 comprising detecting the temperature of the fuel in the fuel injection device 1, 31. Specifically, when it is determined that the temperature of the natural gas in the fuel injection device 1, 31, particularly the fuel distributor passage 6, 36, measured by the sensor 8, 37, for example, is within a predefined temperature range, it is determined that it is necessary to heat the fuel in the distributor passages 6, 36.

Step 109: When it is determined that it is necessary to heat the fuel entering the fuel injection device 1, 31, the heating unit 12, 47 provided in the fuel injection device 1, 31, particularly in the fuel distributor passages 6, 36, is started to heat the fuel, particularly the natural gas.

Alternatively, in step 108, the operating ambient temperature of the fuel injection device 1, 31, the temperature of the fuel before entering the fuel injection device 1,31, the temperature of a water tank of the internal combustion engine, the temperature of the lubricating oil of the internal combustion engine, etc. are further detected.

Optionally, when detecting the temperature of the fuel within the fuel injection device 1, 31, the method further comprises the following steps:

Step 101: The working state of the internal combustion engine is detected, for example, whether the internal combustion engine is in the energization stage, the start-up stage, the idle speed stage, the operation stage or the stalling stage;

Step 102: When it is detected that the operating state of the internal combustion engine is in the energization or start-up stage or the idle speed stage and the temperature of the natural gas in the fuel distributor passages 6, 36 is within a predefined temperature range, it is determined that it is necessary to heat the fuel in the fuel distributor passage 6, 36.

Optionally, when detecting the temperature of the fuel within the fuel injection device 1, 31, the method further comprises:

Step 103: Detecting the rotational speed of the internal combustion engine;

Step 104: When it is detected that the engine rotational speed is within a predetermined range and the temperature of the fuel is within a predefined temperature range, it is determined that it is necessary to heat the fuel in the fuel distributor passages 6, 36.

Optionally, before detecting the temperature of the fuel within the fuel injection device 1, 31, the method further comprises the following steps:

Step 105: Detecting whether there is a failure of the connection between the fuel injection device 1, 31 and the fuel tank, for example, clogging or leaking;

Step 106: Continuing to detect the temperature of the fuel, particularly the natural gas, which is guided into the fuel injection device 1, 31, particularly the fuel distributor passage 6, 36, when no failure of the connection between the fuel injection device 1, 31 and the fuel tank is detected.

It will be appreciated by those skilled in the art that, in different applications or under different technical requirements, the detection of the temperature of the fuel, particularly the natural gas, in the fuel injection device 1, 31, particularly in the fuel distributor passage 6, 36, the detection of the working state of the internal combustion engine and the detection of the rotational speed of the internal combustion engine can be carried out in an adjustable order, or can even be carried out simultaneously.

Specifically, in the present embodiment, the heating unit 12, 47 is heated by an energy storage device such as a storage battery. The heating unit 12, 47 is preferably a tubular electric heating rod made of a metallic electric heating element. When it is determined that it is necessary to heat the fuel entering the fuel injection device 1, 31, the heating safety conditions such as the storage battery voltage are further detected; and the storage battery is allowed to heat the heating unit 12, 47 when the detected safety condition for the heating is approved, for example, when the battery voltage is normal. The controller then sets a target value for heating, for example, a specific temperature value, and starts the heating unit for heating.

Further, the controller comprises a closed-loop control strategy that controls the heating of the heating unit, such that the heating unit outputs different heating powers according to a present voltage state of the storage battery. Specifically, the controller outputs a heating current for a certain time to the heating unit based on the demand of the heating power.

Step 110: The heated fuel is distributed from the fuel distributor passage to the injection valve.

The present invention also discloses a non-volatile memory which stores the fuel heating method 100 applied in the fuel injection device 1, 31. A controller may read the program of the fuel heating method 100 stored in the non-volatile memory and then control the fuel heating in the fuel injection device 1, 31. In the present embodiment, the non-volatile memory is provided inside the controller.

The above description is only preferred embodiments of the invention, not intended to limit the present invention. Any modifications, equivalent replacements, or improvements made within the spirit and principles of the present invention should be included within the scope of protection of the present invention.

1. A fuel injection device (1, 31) comprising an interface member (7, 40), a fuel distributor passage (6, 36), at least one injection valve (14, 15, 16, 17, 33, 34) and a heating unit (12, 47), wherein
the interface member (7, 40) is provided on the fuel distributor passage (6, 36) and is connected to a fuel tank to control fuel fed into the fuel distributor passage (6, 36),
the at least one injection valve (14, 15, 16, 17, 33, 34) is connected to the fuel distributor passage (6, 36), and the fuel is distributed into the at least one injection valve (14, 15, 16, 17, 33, 34) via the fuel distributor passage (6, 36), and
the heating unit (12, 47) heats the fuel in the fuel distributor passage (6, 36), the heating unit (12, 47) comprises a connector (13, 48), and the heating unit (12, 47) is connected to an energy storage apparatus via the connector (13, 48).

2. The fuel injection device (1, 31) according to claim 1, characterized in that the fuel injection device (1, 31) further comprises a fuel distributor (32) and at least one injection valve (33, 34), wherein the fuel distributor (32) comprises a base body (35) provided with the fuel distributor passage (36), and the fuel distributor passage (36) comprises a fuel chamber (39) therein, the fuel being distributed to the at least one injection valve (33, 34) via the fuel chamber (39).

3. The fuel injection device (1, 31) according to claim 1, characterized in that the fuel injection device (1, 31) further comprises a first block element (2) provided with the fuel distributor passage (6) and at least one second block element (3), wherein the at least one injection valve (14, 15, 16, 17) is installed into the second block element (3) by the first block element (2), and the fuel distributor passage (6) distributes the fuel to the at least one injection valve (14, 15, 16, 17).

4. The fuel injection device (1, 31) according to claim 1, characterized in that the heating unit (12, 47) is provided in the fuel distributor passage (6, 36), the connector (13, 48) is provided at an end of the fuel distributor passage (6, 36), the heating unit (12, 47) is an electric heating rod, the heating unit (12, 47) extends from the connector (13, 48) towards the interface member (7, 40) and covers the at least one injection valve (14, 15, 16, 17, 33, 34), and the heating unit (12, 47) is connected to a controller via the connector (13, 48).

5. A fuel heating method used in the fuel injection device (1, 31) according to claim 1, to the fuel injection device (1, 31) comprising a fuel distributor passage (6, 36), wherein the method comprises:
detecting the temperature of fuel in the fuel injection device (1, 31);
determining that the fuel in the fuel injection device (1, 31) needs to be heated when the detected temperature of the fuel in the fuel injection device (1, 31) is in a predefined temperature range; and
activating the heating unit (12, 47) provided in the fuel distributor passage (6, 36) to heat the fuel.

6. The fuel heating method according to claim 5, also comprising
detecting a working state of an internal combustion engine while detecting the temperature of the fuel in the fuel injection device (1, 31), and
determining that the fuel in the fuel injection device (1, 31) needs to be heated, when it is detected that the working state of the internal combustion engine is in an energized or start stage or an idle speed stage and when the detected temperature of the fuel in the fuel injection device (1, 31) is in a predefined temperature range.

7. The fuel heating method according to claim 6, also comprising
detecting the rotational speed of the internal combustion engine while detecting the temperature of the fuel in the fuel injection device (1, 31), and
determining that the fuel in the fuel injection device (1, 31) needs to be heated when the detected rotational speed of the internal combustion engine is in a predefined range and when the detected temperature of the fuel in the fuel injection device (1, 31) is in a predefined temperature range.

8. The fuel heating method according to claim 5, also comprising
detecting whether there is a failure of the connection between the fuel injection device (1, 31) and the fuel tank before detecting the temperature of the fuel in the fuel injection device (1, 31), and
if a failure of the connection between the fuel injection device (1, 31) and the fuel tank is detected, the fuel in the fuel injection device (1, 31) is not to be heated.

9. The fuel heating method according to claim 8, characterized by the step of activating the heating unit (12, 47) provided in the fuel distributor passage (6, 36) to heat the fuel comprising: using the energy storage apparatus to heat the heating unit (12, 47) after it is determined that the fuel in the fuel injection device (1, 31) needs to be heated; also determining whether the energy storage apparatus complies with a safety requirement for heating before using the energy storage apparatus to heat the heating unit (12, 47); and using the energy storage apparatus to heat the heating unit (12, 47) when it is determined that the safety requirement for heating is satisfied.

10. A non-volatile memory storing a computer program therein, the computer program enabling a computer to execute a method according to claim 5 used in a fuel distributor device (1, 31).
